(19) United States
(12) Patent Application Publication
(10) Pub. No.: US 2011/0002395 A1
(43) Pub. Date: Jan. 6, 2011

(54) DEBLOCKING FILTERING PROCESSOR AND DEBLOCKING FILTERING METHOD

(75) Inventor: Kosuke Nishihara, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/735,997

(22) PCT Filed: Mar. 27, 2009
(86) PCT No.: PCT/JP2009/056228

§ 371 Date: Aug. 31, 2010

(30) Foreign Application Priority Data
Mar. 31, 2008 (JP) 2008-089745

(51) Int. Cl. H04N 7/12

(52) U.S. Cl. 375/240.24; 375/E07.026

(57) ABSTRACT

A deblocking filtering processor includes a first deblocking filtering section provided with a typical filter intensity calculation section and a typical filter section. The typical filter intensity calculation section selects a predetermined pixel line among a plurality of pixel lines crossing a block boundary as a typical pixel line for decoded image data of a moving image that are coded in units of blocks, and performs a filter intensity calculation to obtain a typical filter intensity on the basis of pixel values included in the typical pixel line. The typical filter section provides smoothing for pixel values included in the plurality of pixel lines on the basis of the typical filter intensity.

### TECHNICAL FIELD

The present invention relates to a deblocking filtering processor and a deblocking filtering method.

### BACKGROUND ART

In a video codec that performs coding in units of blocks, rectangular distortion called block noise is likely to occur in a decoded image. The block noise results from a fact that pixel values of pixels on both sides across the block boundary are discontinuous and therefore the block boundary is clearly perceived, when the code amount is insufficient. Accordingly, in order to improve the image quality, a deblocking filter is often applied which smoothes the discontinuous boundary occurring in the decoded image data. Since uniform smoothing of an image in the same frame may unnecessarily cause blur in the image, the deblocking filter adaptively determines on the basis of the pixel values at the boundary whether or not to be applied, and if applied, how intensely the smoothing is performed.

In particular, as indicated in ITU-T Recommendation H.264 (Advanced Video Coding for Generic Audiovisual Services, March 2005), which is commonly known as the “H.264/MPEG-4 AVC standard (hereinafter described as H.264)”, specifications of the deblocking filter are incorporated in the standard. In decoding processing of H.264, integer conversion is performed in units of 4×4 pixel blocks, and therefore the deblocking filter is also applied on the 4×4 pixel block boundaries. FIG. 1 is a diagram illustrating 4×4 pixel block boundaries in one macro block. In the one macro block, four 4×4 pixel blocks are arranged in the horizontal direction, and four 4×4 pixel blocks are arranged in the vertical direction. Accordingly, one macro block includes sixteen 4×4 pixel blocks in total, and also includes sixteen block boundaries in the horizontal direction and sixteen block boundaries in the vertical direction.

The deblocking filter performs, for each pixel line crossing a block boundary, a filter intensity calculation that determines whether nor not the filter is applied, and if the filter is applied, how intensely the smoothing is performed. Then, the deblocking filter applies selected one of filters having different effects depending on pixel values included in the pixel line. For example, as illustrated in FIG. 2, a block boundary 1031 between 4×4 pixel blocks 1021 and 1022 includes four pixel lines 1041 to 1044. Each of the pixel lines 1041 to 1044 includes four pixels 1010 of the 4×4 pixel block 1021 and four pixels 1010 of the 4×4 pixel block 1022. On the basis of the pixel values of the eight pixels 1010 included in each of the pixel lines 1041 to 1044, the filter intensity calculation is adaptively performed and the filter processing is applied. That is, the filter intensity calculation is performed four times for the 4×4 pixel block boundary 1031.

Although effectively reducing the block noise to improve image quality, the deblocking filter suffers from a problem of a large required calculation amount. For this reason, in a case where the available calculation amount is not sufficient, for example, in a mobile device, there is proposed a method for reducing a required calculation amount by skipping a deblocking filter, as disclosed in Japanese Patent Application Publication No. P2007-208552A, for example. In this method, as illustrated in FIG. 3, deblocking filtering is obviated. First, the calculation load of the data processor is obtained (S1001) to determine the amount of the calculation load (S1002). If the load is small (S1002-Yes), the deblocking filtering is normally performed (S1003). If the load is large (S1002-No), the deblocking filtering is skipped (S1004). The above steps are repeated until the end of a frame (S1005). However, such a control method based on choice between two alternatives which selects whether or not to apply the deblocking filter causes a problem of large deterioration in image quality.

Also, Japanese Patent Application Publication No. P2007-27956A discloses a deblocking filter including video stream information acquisition means, a plurality of high image quality processing filters, and high image quality filter switching means. The video stream information acquisition means extracts bit rate information in a video stream and image size information from the video stream. The plurality of high image quality processing filters carries out deblocking filtering for enhancing the image quality of an image reproduced on the basis of the video stream. One or more of the high image quality processing filters are first type high image quality processing filters that perform the deblocking filtering at higher speed than the other high image quality processing filters. Also, one or more of the high image quality processing filters are second type high image quality processing filters that perform the deblocking filtering at lower speed than the first type high image quality processing filters. The high image quality filter switching means switches, on the basis of any one or more of the bit rate information and the image size information, the high image quality processing filters for applying the deblocking filtering to the video stream. That is, on the basis of any one or more of the bit rate information and the image size information, the high image quality filter switching means determines whether or not to switch to the first type high image quality processing filters, and if so, switches to the first type high image quality processing filters.

Japanese Patent Application Publication No. P2007-129318A discloses an image decoder that generates a decoded image by decoding image-encoded data obtained by encoding an image. The image decoder includes decoding means, throughput calculation means, filter strength determination means, and filtering means. The decoding means generates a decoded image by decoding image encoded data. The throughput calculation means calculates throughput by the decoding means that decodes the image encoded data. The filter strength determination means determines filter strength on the basis of the throughput calculated by the throughput calculation means. The filtering means filters the decoded image on the basis of the filter strength determined by the filter strength determination means.

Also, Japanese Patent Application Publication No. P2001-285866A discloses an image decoding device that performs resolution conversion of a ratio of N/M (N and Mare integers) in the orthogonal conversion region. The image decoding device includes inverse converting means and thinning-out means. The inverse converting means performs inverse orthogonal conversion of k×N (k is an integer) orthogonal conversion coefficients. The thinning-out means thins out the conversion result of the inverse converting means to 1/k. That is, a block size converting circuit converts the block size of DCT (Discrete Cosine Transform) coefficient data outputted from an inverse quantizing circuit into a size corresponding to desired resolution in the horizontal direction and into a size corresponding to a resolution of twice of a desired resolution in the vertical direction. An inverse DCT converting circuit implements inverse DCT-conversion on the DCT conversion coefficient data output of the block size converting circuit by the corresponding block size. A scan converter converts output data of the inverse DCT converting circuit in the order of the raster scanning. A filter provides band restriction for the output of the scan converter in the vertical direction for thinning out, and a sub-sampling circuit performs thinning-out in the vertical direction. The filter restricts the band through the use of pixel data of a different DCT block.

### DISCLOSURE OF INVENTION

An object of the present invention is to provide a deblocking filtering processor, a deblocking filtering method, and a deblocking filtering program that which reduce the required calculation amount with suppressing deterioration in image quality.

In an aspect of the present invention, a deblocking filtering processor includes a first deblocking filtering section provided with a typical filter intensity calculation section and a typical filter section. The typical filter intensity calculation section selects a predetermined pixel line among a plurality of pixel lines crossing a block boundary as a typical pixel line for decoded image data of a moving image that are coded in units of blocks, and performs a filter intensity calculation to obtain a typical filter intensity on the basis of pixel values included in the typical pixel line. The typical filter section provides smoothing for pixel values included in the plurality of pixel lines on the basis of the typical filter intensity.

In another aspect of the present invention, a deblocking filtering method includes a step of performing first deblocking filtering processing provided with steps of: selecting a typical pixel line; calculating a typical filter intensity; and providing smoothing. In the step of selecting the typical pixel line, a predetermined pixel line among a plurality of pixel lines crossing a block boundary is selected as the typical pixel line for decoded image data of a moving image which are coded in units of blocks. In the step of calculating the typical filter intensity, a filter intensity calculation is performed to obtain the typical filter intensity on the basis of pixel values included in the typical pixel line. In the step of providing smoothing, pixel values included in the plurality of pixel lines are subjected to the smoothing on the basis of the typical filter intensity obtained in the step of calculating the typical filter intensity.

In still another aspect of the present invention, a storage medium which stores a deblocking filtering program is a medium that stores a program for causing a computer to perform a first deblocking filtering step. The first deblocking filtering step includes a representative pixel line setting step, a representative filter intensity calculation step, and a representative filter step. In the representative pixel line setting step, a predetermined pixel line among a plurality of pixel lines crossing a block boundary is set as a representative pixel line for decoded image data of a moving image which are coded in units of blocks. In the representative filter intensity calculation step, a filter intensity calculation is performed to obtain a representative filter intensity on the basis of pixel values included in the set representative pixel line. In the representative filter step, pixel values included in the plurality of pixel lines are subjected to smoothing on the basis of the obtained representative filter intensity.

The present invention provides a deblocking filtering processor, a deblocking filtering method, and a deblocking filtering program which reduce the required calculation amount with suppressing deterioration in image quality.

### BRIEF DESCRIPTION OF DRAWINGS

The above-described object, effect, and features of the invention will be more clarified from the description of exemplary embodiments in conjunction with the accompanying drawings.

FIG. 1 is a diagram illustrating 4×4 pixel block boundaries in a macro block;

FIG. 2 is a diagram illustrating pixel lines in a 4×4 pixel block boundary;

FIG. 3 is a diagram illustrating a method for reducing the required calculation amount by skipping a deblocking filter;

FIG. 4 is a block diagram illustrating the configuration of a deblocking filtering processor in a first exemplary embodiment of the present invention;

FIG. 5 is a diagram illustrating the configuration of a computer device that performs deblocking filtering in the first exemplary embodiment of the present invention;

FIG. 6 is a flowchart illustrating the operation of the deblocking filtering processor in the first exemplary embodiment of the present invention;

FIG. 7 is a block diagram illustrating the configuration of a deblocking filtering processor in a second exemplary embodiment of the present invention; and

FIG. 8 is a flowchart illustrating operation of the deblocking filtering processor according to the second exemplary embodiment of the present invention.

### DESCRIPTION OF EMBODIMENTS

In the following, exemplary embodiments for carrying out the present invention are described, referring to the drawings.

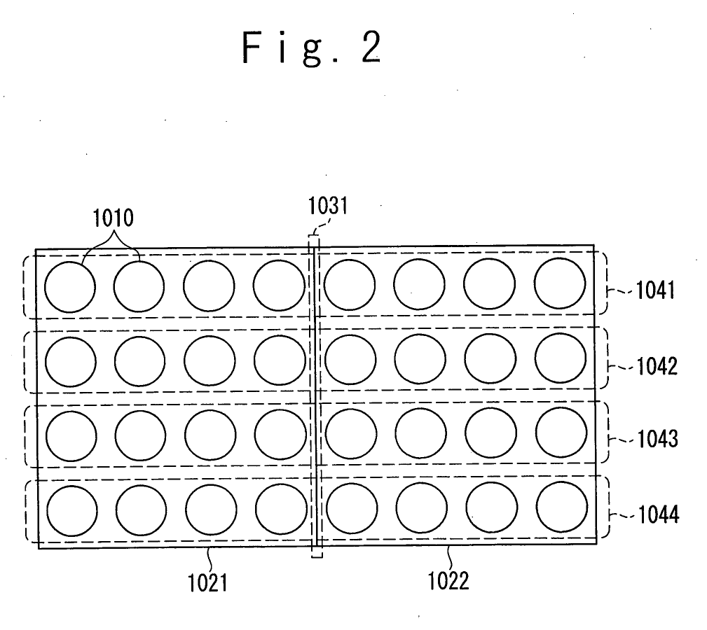

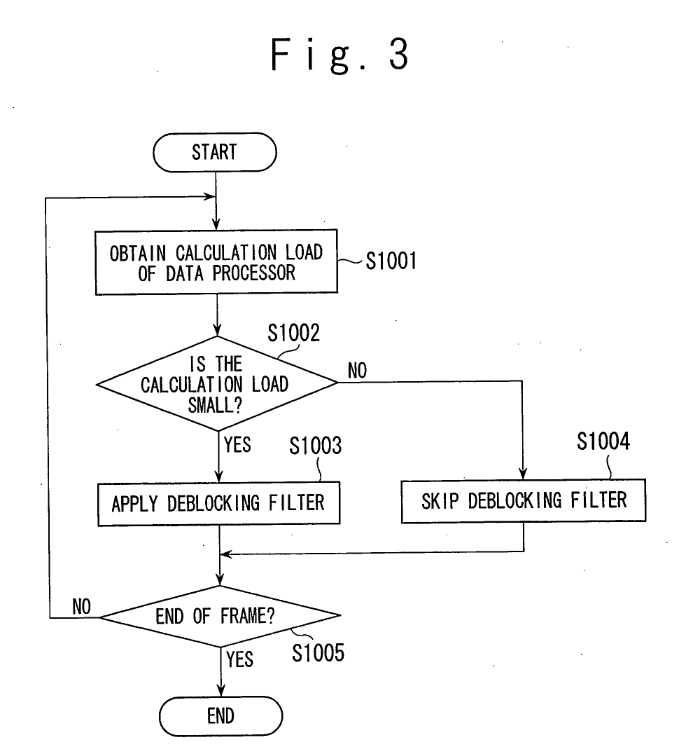

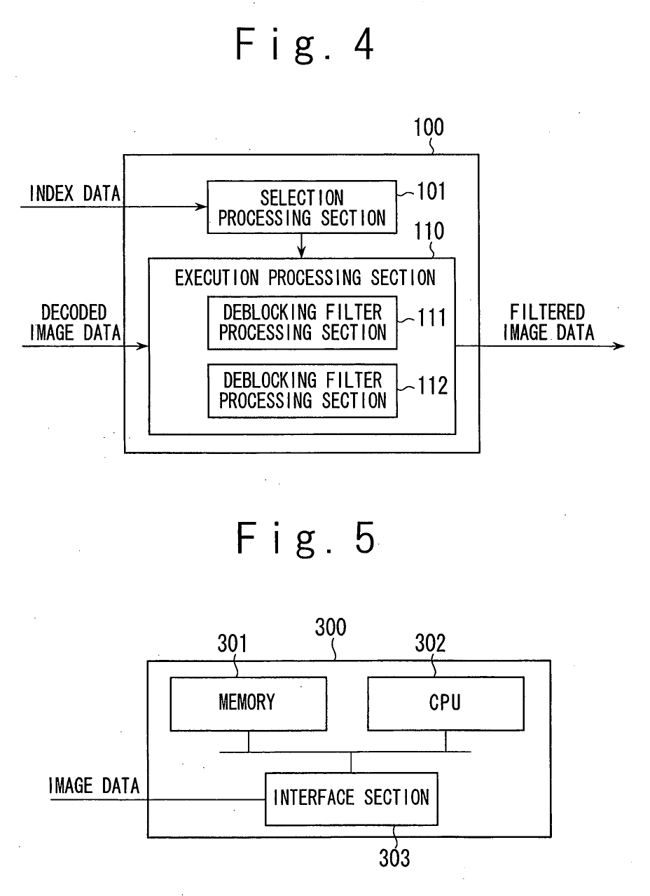

FIG. 4 illustrates the configuration of a deblocking filtering processor 100 in a first exemplary embodiment. The deblocking filtering processor 100 performs filter intensity calculations on inputted decoded image data for every predetermined number of pixel lines, and applies selected one of filters having different effects depending on pixel values included in the pixel line. The filter intensity calculations are performed on the pixel lines crossing a 4×4 pixel block boundary as illustrated in FIG. 2. That is, in performing the filter intensity calculations on all of the pixel lines of the block boundary 1031, four filter intensity calculations are performed on the block boundary 1031, i.e., one intensity calculation for each of the pixel lines 1041 to 1044. The deblocking filtering processor 100 appropriately thins out the filter intensity calculations to thereby reduce a required calculation amount.

As illustrated in FIG. 4, the deblocking filtering processor 100 is provided with an execution processing section 110 and a selection processing section 101. The execution processing section 110 performs the deblocking filtering on decoded image data of a moving image that is coded in units of blocks, and outputs the filtered image data. The execution processing section 110 is provide with deblocking filtering sections 111 and 112 which respectively perform different deblocking processes, and performs any of the deblocking processes. The deblocking filtering sections 111 and 112 can respectively perform a plurality of deblocking filtering in parallel. The selection processing section 101 selects, on the basis of inputted index data, one of the deblocking filtering sections 111 and 112 to notify the execution processing section 110 of the selection.

The deblocking filtering section 111 performs a filter intensity calculation for each of pixel lines to be subjected to the deblocking filtering. That is, the deblocking filtering section 111 is a processing section that performs one filter intensity calculation on one pixel line, and on the basis of a result of the calculation, performs filter processing, which is smoothing processing. The deblocking filtering section 112 performs a filter intensity calculation on one pixel line out of a plurality of pixel lines. That is, the deblocking filtering section 112 is a processing section that performs the filter intensity calculation with one pixel line serving as a typical pixel line among N pixel lines, and on the basis of the filter intensity of the typical pixel line, performs filter processing that is smoothing processing of the N pixel lines. Regarding the other N-1 pixel lines, the filter intensity calculation value for the typical pixel line is diverted to perform the filter processing on each of the pixel lines. Accordingly, the filter processing is performed; however, the throughput amount of the filter intensity calculation is reduced down to 1/N.

A description is given of the operation of the deblocking filtering processor 100. First, the selection processing section 101 selects, on the basis of externally received index data, any of the deblocking filtering sections 111 and 112. The index data include, for example, a processing time for moving image decoding processing. When the processing time for the moving image decoding processing is equal to or less than a predetermined value, the selection processing section 101 selects the deblocking filtering section 111, whereas when the processing time exceeds the predetermined value, the selection processing section 101 selects the deblocking filtering section 112. The result of the selection is notified to the execution processing section 110.

The execution processing section 110 applies the deblocking filtering to the inputted decoded image data by using the deblocking filtering section 111 or 112 selected by the selection processing section 101. The deblocking filtering section 111 performs the filter intensity calculation for each pixel line to determine how intensely the smoothing is to be performed, and then applies or does not apply a deblocking filter. That is, the filter intensity calculation is performed once for every one pixel line. The deblocking filtering section 112 performs the filter intensity calculation for each typical pixel line out of the plurality of pixel lines. That is, the filter intensity calculation is performed once for N pixel lines. In this case, the result of the filter intensity calculation on the typical pixel line is applied as the filter intensities of the other N-1 pixel lines. This results in that the result of the filter intensity calculation on the typical pixel line is representatively used for the N pixel lines.

In this case, the reason why the result of the filter intensity calculation on some representative pixel line can be also used for the other plurality of pixel lines is based on the knowledge that, in general, pixel values of adjacent pixels are similar in tendency. Accordingly, as the number of pixel lines applied with the same calculation result is increased, the pixel line representatively used for the filter intensity calculation is positioned away from peripherally positioned pixel lines, which results in a difference from the filter processing result obtained by performing the filter intensity calculation for each of the pixel lines. Accordingly, in order to reduce the difference as much as possible, a pixel line positioned spatially in the middle is preferably selected as the typical pixel line representing the filter intensity calculation.

Also, the index data for selecting the deblocking filtering section 111 or 112 may include not only the processing time for the moving image decoding processing but also another parameter required for the deblocking filtering. The selection processing section 101 may obtain the parameter to select the filter intensity calculation method on the basis of the calculation load of the deblocking filtering and the parameter. As the parameter, the filter intensity value, quantization value, block type, or the like is preferable.

It should be noted that each of the processing sections illustrated in FIG. 4 is a predetermined functional unit realized by any of a software program and hardware in an actual implementation of the deblocking filtering processor of this exemplary embodiment. Accordingly, some or all of the respective processing sections may be implemented as hardware.

In an implementation based on a software program, as illustrated in FIG. 5, the software program is executed on a computer device 300 provided with a memory 301, a CPU (Central Processing Unit) 302, and an interface part 303. The software program is stored in the readable/writable memory 301 (or a storage medium). The CPU 302 reads the software program from the memory 301 to execute it. Image data are interfaced through the interface section 303. In such a case, the present invention is constituted by codes of such a software program or the storage medium.

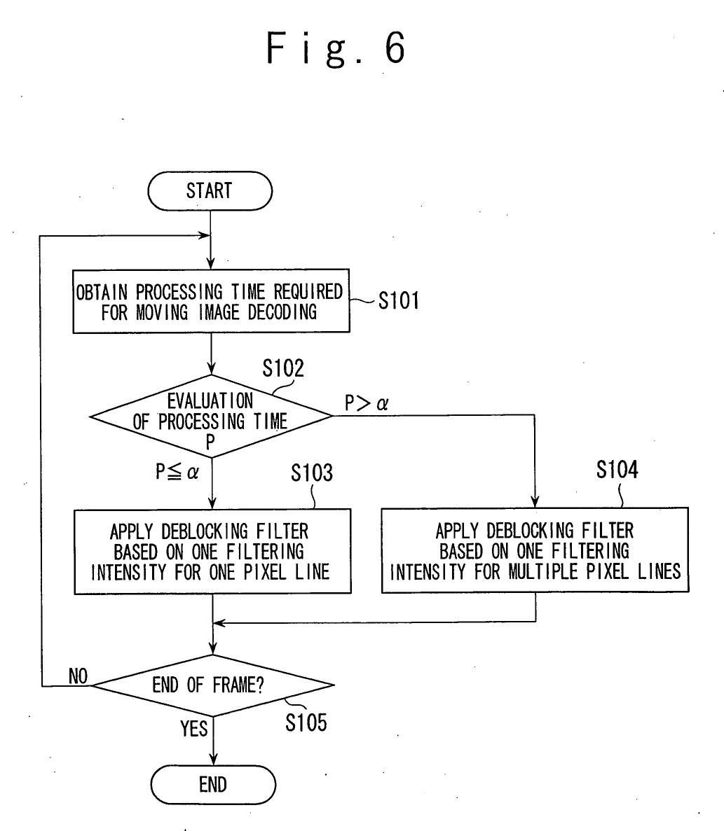

Next, a description is given of an operational procedure for a case of application to one frame image data, referring to FIG. 6. The flowchart illustrated in FIG. 6 represents a processing procedure of the software program executed by the CPU 302 in the computer device 300 illustrated in FIG. 5. Accordingly, the functional units illustrated in FIG. 4 are described as the software program executed by the CPU 302.

The CPU 302 executes a selection processing program 101 to acquire a processing time P required for the moving image decoding (Step S101). The CPU 302 compares the acquired processing time P with a predetermined value α to provide an evaluation (Step S102). When the result of the evaluation proves that the processing time P is equal to or less than the predetermined value α (Step S102: P≦α), the CPU 302 executed the deblocking filtering program 111 that performs the filter intensity calculation for each pixel line. That is, on the basis of the filter intensity calculated for each pixel line, the deblocking filter is applied to decoded image data (Step S103). When the processing time P exceeds the predetermined value α (Step S102: P>α), the CPU 302 executes the deblocking filtering program 112. That is, the deblocking filter is applied to the decoded image data on the basis of a filter intensity obtained by performing the filter intensity calculation only on a typical pixel line selected from among the plurality of pixel lines (Step S104). Accordingly, the deblocking filtering is simplified to reduce the processing time to ensure the processing time spent for the moving image decoding processing more than envisaged, and therefore the total processing time can be reduced within a predetermine period of time. When the moving image decoding processing is completed within the envisaged period of time, the filter intensity calculation can be performed for each pixel line to obtain higher image quality. The CPU 302 repeats the above processing steps until the end of the frame (Step S105).

As described, the present invention effectively simplifies the filter intensity calculation for each pixel line and thereby reduces the processing time. A typical adaptive deblocking filter determines whether or not the filter is applied, and if so, a filter intensity calculation is performed for each pixel line, and the filter is then applied to the pixel column after the calculation. In the deblocking filter of the present invention, the filter intensity calculations are simplified, out of the filter intensity calculations and filter applying processing. The filter intensity calculations on a plurality of pixel lines are represented by that on a predetermined pixel line (typical pixel line), and the filter intensity calculations on the other pixel lines are omitted to achieve the simplification. That is, the filter intensity calculations are thinned. After the thinned filter intensity calculations, the filter is applied on the basis of the result of the calculation representing the plurality of pixel lines. The simplification is performed on the basis of a given parameter, such as the progress of the decoding processing including the deblocking filter.

As described, the one-pixel-line-based deblocking filter intensity calculations are simplified to a multiple-pixel-line-based calculation in this exemplary embodiment, on the basis of the processing time for the moving image decoding processing. The simplification is not a simplifying method involving a choice between two alternatives which determines whether or not the deblocking filter is applied; the filter processing itself is performed although the filter intensity calculations are simplified. Therefore, an effect of the deblocking filter can be obtained, while the required calculation amount can be reduced along with the suppression of deterioration in the image quality.

Next, a description is given of a second exemplary embodiment. A deblocking filtering processor 200 of this exemplary embodiment is a deblocking filtering processor supporting the H.264/MPEG-4 AVC standard (hereinafter described as H.264). Parameters involving the selection of the deblocking filtering include at least one of a filter intensity value (Boundary Strength: bS), a quantization value (Quantisation Parameter: QP), and a macro block type.

In H.264, the specifications of the deblocking filter are strictly provided. Accordingly, the deblocking filtering processor 200 of this exemplary embodiment is adapted to switch between deblocking filtering of the H.264 standard and thinning deblocking filtering of the present invention. Therefore, the deblocking filter simplification of the present invention is effective when priority is given to reduction in the required calculation amount whereas some deterioration in image quality is allowed.

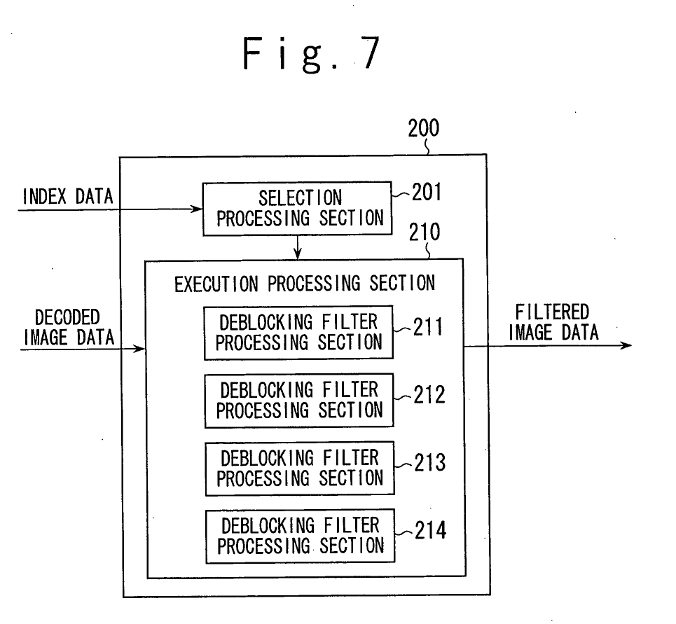

FIG. 7 illustrates the configuration of the deblocking filtering processor 200 in the second exemplary embodiment. The deblocking filtering processor 200 is provided with an execution processing section 210 and a selection processing section 201. The execution processing section 210 performs the deblocking filtering on decoded image data of a moving image that is coded on a block basis, and outputs the filtered image data. The execution processing section 210 is provide with deblocking filtering sections 211 to 214 that respectively perform different deblocking processes, and performs any of the deblocking processes. The deblocking filtering sections 211 to 214 can perform a plurality of deblocking filterings in parallel, respectively. The selection processing section 201 selects, on the basis of inputted index data, any of the deblocking filtering sections 211 to 214 to notify the execution processing section 210 of the selection.

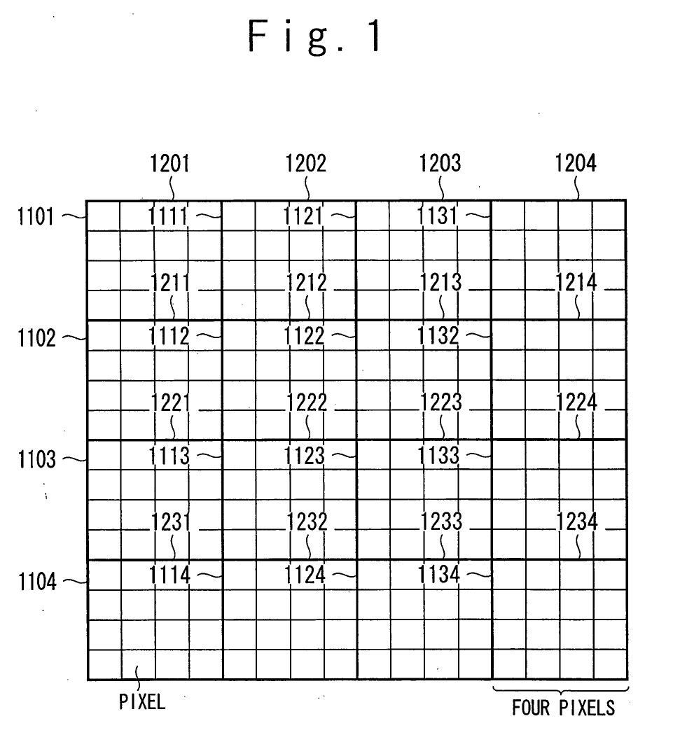

The deblocking filtering section 211 performs the deblocking filtering stipulated under the H.264 standard. Accordingly, the filter intensity calculation is performed for each pixel line. For the macro block as illustrated in FIG. 1, there are thirty-two 4×4 pixel block boundaries, and 128 filter intensity calculations are performed.

The deblocking filtering section 212 thins out four filter intensity calculations on four pixel lines belonging to one 4×4 pixel block boundary down to one filter intensity calculation in performing the deblocking filtering. To give a description with use of the pixel lines illustrated in FIG. 2, for example, filter intensities respectively associated with the pixel lines 1041 to 1044 are represented by a result of the filter intensity calculation performed on the pixel line 1042. Such thinning-out is performed for each block boundary. For the macro block as illustrated in FIG. 1, there are the thirty-two 4×4 pixel block boundaries, and the same number of, i.e., thirty-two filter intensity calculations are performed. Accordingly, the number of filter intensity calculations can be reduced to ¼.

The deblocking filtering section 213 thins out sixteen filter intensity calculations on sixteen pixel lines belonging to vertically or horizontally continuous four 4×4 pixel block boundaries within one macro block down to one filter intensity calculation to perform the deblocking filtering. To give a description with use of the vertically continuous 4×4 pixel block boundaries illustrated in FIG. 1, for example, regarding the block boundaries 1111 to 1114, the deblocking filtering section 213 performs the filter intensity calculation, using one pixel line close to the block boundaries 1221 and 1222 as being a typical one, and performs the filter processing. Regarding the other fifteen pixel lines included in the block boundaries 1111 to 1114, the result of the filter intensity calculation is used to perform the filter processing. Also, the filter intensity calculations are thinned out in the same manner for the block boundaries 1101 to 1104, 1121 to 1124, and 1131 to 1134. Further, the filter intensity calculations are thinned in the same manner for the block boundaries 1201 to 1204, 1211 to 1214, 1221 to 1224, and 1231 to 1234. For the macro block as illustrated in FIG. 1, four filter intensity calculations are performed in the horizontal direction, and four filter intensity calculations are performed in the vertical direction. Accordingly, the number of filter intensity calculations can be reduced to one-sixteenth.

The deblocking filtering section 214 thins out sixty-four filter intensity calculations on sixty-four pixel lines belonging to vertically sixteen and horizontally sixteen 4×4 pixel block boundaries within one macro block down to one filter intensity calculation to perform the deblocking filtering. For the vertical block boundaries 1101 to 1104, 1111 to 1114, 1121 to 1124, and 1131 to 1134 illustrated in FIG. 1, for example, the block boundary 1122 adjacent to the block boundary 1222 in the middle of the macro block is selected as a typical block boundary representing the adjacent block boundaries. The filter intensity calculation is performed with using one pixel line included in the block boundary 1122 as a typical one, and the filter processing is performed. Regarding the other three pixel lines included in the block boundary 1122 and fifty pixel lines included in the other vertical block boundaries, a result of the filter intensity calculation is used to perform the filter processing. Also, for the horizontal block boundaries 1201 to 1204, 1211 to 1214, 1221 to 1224, and 1231 to 1234, the filter intensity calculations are thinned in the same manner, and the result of the filter intensity calculation for the typical pixel lube is used to perform the filter processing. In the case of the macro block as illustrated in FIG. 1, one filter intensity calculation is performed in the horizontal direction, and one filter intensity calculation is performed in the vertical direction. Accordingly, the number of filter intensity calculations can be reduced to 1/64.

The selection processing section 201 receives, for example, a processing time for the moving image decoding processing as the index data. When the processing time P is equal to or less than the predetermined setting value α, the selection processing section 201 selects the deblocking filtering section 211 and notifies the execution processing section 210 of the selection. When the processing time P exceeds the setting value α, i.e., the processing is delayed, the selection processing section 201 selects any of the deblocking filtering sections 212 to 214 on the basis of the degree of the delay, i.e., the delay time D=P−α, and notifies the execution processing section 210 of the selection. For this purpose, two step threshold values β1 and β2 are set to evaluate the delay time D. When the delay time D is equal to or less than the threshold value β1, the selection processing section 201 selects the deblocking filtering section 212; when the delay time D exceeds the threshold value β1 and is equal to or less than the threshold value β2, the selection processing section 201 selects the deblocking filtering section 213; and when the delay time D exceeds the threshold value β2, the selection processing section 201 selects the deblocking filtering section 214.

Also, a parameter required for the deblocking filtering may be inputted as the index data, and the above selected simplification method may be adjusted on the basis of the parameter. In a case where the bS value or the QP value is large, for example, the deblocking filter is intensely applied, and therefore, image quality deterioration is further increased if the simplified deblocking filtering is applied. For this reason, the adjustment is made so as to weaken the simplification by one step if the bS value is 4. When the deblocking filtering section 213 is selected in the above, for example, the deblocking filtering section 213 is changed to the deblocking filtering section 212. Also, the simplification may be weakened by one step in the same manner, when the QP value exceeds a predetermined threshold value.

Although the simplified deblocking filtering is described as being performed with the filter intensity calculations thinned out to ¼, 1/16, or 1/64 in this exemplary embodiment, the thinning-out method is not limited to this. The thinning-out method is easily expanded to simplified deblocking filtering in which filter intensity calculations on pixel lines belonging to N block boundaries are thinned out to one filter intensity calculation, wherein N is an integer equal to or more than one. It should be noted that the execution processing section 210 will be provided with M types of deblocking filterings, when N is selected from one to an integer M. In this case, the execution processing section 210 may be provided with M types of simplified deblocking filterings. Alternatively, the execution processing section 210 may be provided with one processing section that realizes deblocking filtering in which filter intensity calculations on pixel lines belonging to N block boundaries are thinned out to one filter intensity calculation after N is specified. The selection processing section 201 may operate so as to select N on the basis of the delay time D from the setting value α for the processing time P, if the processing time P is delayed as compared with the setting value α. In such a case, it is only necessary to predetermine (M-1) step threshold values β for the delay time D.

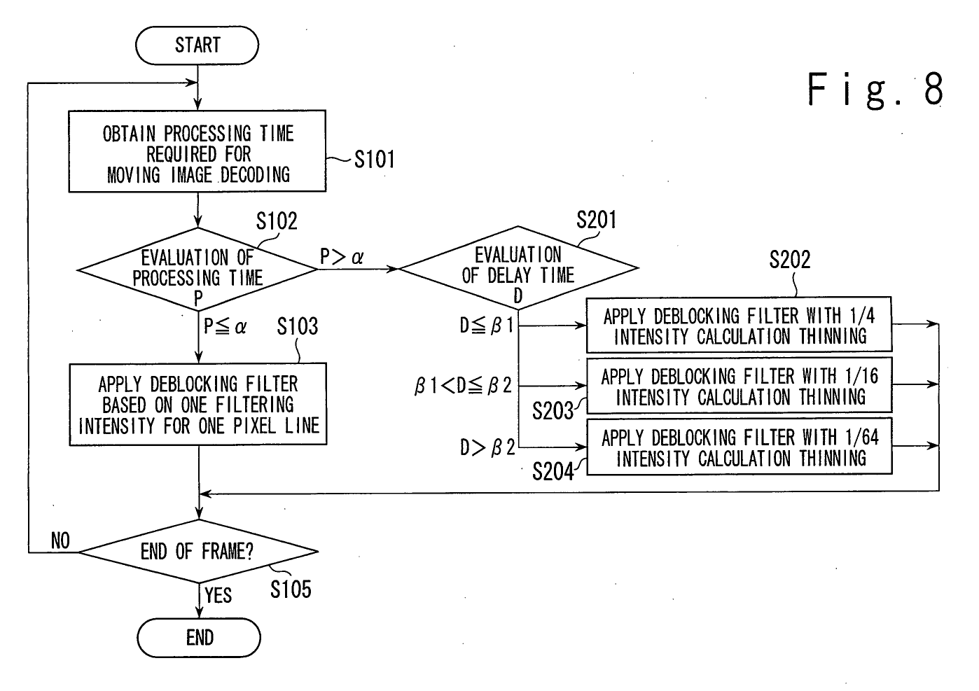

Next, a description is given of the operation of the deblocking filtering processor 200 is described referring to FIG. 8. Steps S101 to S103, and S105 are described again, although they are already described in the first exemplary embodiment.

A CPU 302 executes a selection processing program 101 to acquire the processing time P required for the moving image decoding processing (Step S101). The CPU 302 compares the acquired processing time with the predetermined value α to provide an evaluation (Step S102). When the result of the evaluation proves that the processing time P is equal to or less than the predetermined value α (Step S102: P≦α), the CPU 302 executes the deblocking filtering program 211 that performs the filter intensity calculation for each pixel line to apply the deblocking filter to decoded image data (Step S103). When the processing time P exceeds the predetermined value α (Step S102: P>α), the CPU 302 evaluates the delay time D which is the difference from the predetermined value α (Step S201).

If the delay value D is equal to or less than the first threshold value β1 (Step S201: D≦β1), the CPU 302 executes the deblocking filtering program 212. That is, the decoded image data are applied with the deblocking filter that thins out four filter intensity calculations on four pixel lines belonging to one 4×4 pixel block boundary down to one filter intensity calculation (Step S202).

If the delay value D is larger than the first threshold value β1, and equal to or less than the second threshold value β2 (Step S201: β1<D≦β2), the CPU 302 executes the deblocking filtering program 213. That is, the decoded image data are applied with the deblocking filter that thins out sixteen filter intensity calculations on sixteen pixel lines belonging to vertically or horizontally continuous four 4×4 pixel block boundaries within one macro block down to one filter intensity calculation (Step S203).

If the delay value D is larger than the second threshold value β2 (Step S201: D>β2), the CPU 302 executes a deblocking filtering program 214. That is, the decoded image data are applied with the deblocking filter that thins out sixty-four filter intensity calculations on sixty-four pixel lines belonging to vertically sixteen and horizontally sixteen 4×4 pixel block boundaries within one macro block down to one filter intensity calculation to perform the processing. (Step S204). The CPU 302 repeats the above processing steps until the end of the frame (Step S105).

As described above, the calculation load of the moving image decoding processing or the parameter required for the deblocking filtering is also used to simplify the number of deblocking filter intensity calculations stepwise in this exemplary embodiment. This allows flexibly adjusting the trade-off between deterioration in image quality and reduction in required calculation amount. It should be noted that, although the deblocking filtering in 4×4 pixel block boundaries is described in the above, the block boundaries are not limited to the 4×4 pixel block boundaries, but may be pixel block boundaries having a different configuration.

In implementing the present invention as a program for instructing a computer to carry out the present invention, the deblocking filtering program includes a first deblocking filtering process provided with steps of: setting a typical pixel line; obtaining a typical filter intensity; and smoothing pixel values. In the step of setting the typical pixel line, a predetermined pixel line among a plurality of pixel lines straddling a block boundary is defined as the typical pixel line for decoded image data of a moving image which are coded in units of blocks. In the step of obtaining the typical filter intensity, a filter intensity calculation is performed to obtain the typical filter intensity on the basis of pixel values included in the typical pixel line. In the step of smoothing the pixel values, the pixel values included in the plurality of pixel lines are smoothed on the basis of the obtained typical filter intensity.

The deblocking filtering program may include, in the step of setting the typical pixel line, a step of setting a pixel line positioned in the middle of the block boundary as the typically pixel line.

Also, the deblocking filtering program may further include a second blocking filter processing provided with steps of: obtaining a filter intensity for each of the plurality of pixel lines on the basis of pixel values included in each of the plurality of pixel lines; and smoothing the pixel values included in the plurality of pixel lines. In such a case, the deblocking filtering program includes a step of switching the deblocking filtering on the decoded image data to the first or second deblocking filtering on the basis of inputted index data.

Also, the deblocking filtering program is preferably configured such that the first deblocking filtering further includes a step of setting a predetermined block boundary among a plurality of block boundaries as a typical block boundary; the step of obtaining the typical filter intensity includes a step of obtaining the typical filter intensity on the basis of the pixel values included in the typical pixel line in the typical block boundary; and the step of smoothing the pixel values includes a step of, smoothing the pixel values included in the pixel lines belonging to the plurality of block boundaries, on the basis of the typical filter intensity in the typical pixel line of the typical block boundary.

The above-described index data preferably include at least one of the processing time for the decoding processing of the decoded image data and parameters required for the deblocking filtering.

Also, the second deblocking filtering may include a step of performing the deblocking filtering in the H.264/MPEG-4 AVC standard, and in such a case, parameters required for the deblocking filtering preferably include at least one of the bS (Boundary Strength) value, QP (Quantisation Parameter) value, and macro block type.

In such a case, the first deblocking filtering may include at least one processing step among the following first to third processing steps. In the first processing step, one of four pixel lines belonging to a 4×4 pixel block boundary is used as the typical pixel line to obtain the typical filter intensity, which is applied to the smoothing processing of the four pixel lines to perform the deblocking filtering. In the second processing step, a predetermined number of pixel lines out of sixteen pixel lines belonging to vertically or horizontally continuous 4×4 pixel block boundaries within a macro block in which 4×4 pixel blocks are arranged in a 4×4 matrix form is used as the typical pixel line to obtain the typical filter intensity, which is applied to the smoothing processing of the sixteen pixel lines to perform the deblocking filtering. In the second processing step, a predetermined pixel line out of sixty-four pixel lines belonging to vertically and horizontally 4×4 pixel block boundaries included in a macro block is used as the typical pixel line to obtain the typical filter intensity, which is applied to the smoothing processing of the sixty-four pixel lines belonging to the vertically and horizontally 4×4 pixel block boundaries to perform the deblocking processing. In such a case, the step of switching the deblocking processing preferably includes a step of switching from the first to the third processing step or the second deblocking filtering to perform the deblocking filtering, on the basis of the index data.

As described above, the present invention provides a deblocking filtering processor, a deblocking filtering method, and a deblocking filtering program which reduce the required calculation amount while suppressing deterioration in the image quality.

Although the present invention are described, referring to the exemplary embodiments in the above, the present invention is not limited to any of the above-described exemplary embodiments. Various modifications that the one having ordinary skill in the art would understand within the scope of the present invention may be made to a configuration and details of the present invention.

It should be noted that the present application claims priority based on Japanese patent application No. 2008-089745, the disclosure of which is incorporated herein by reference.

1. A deblocking filtering processor, comprising:
first deblocking filtering means which includes:
typical filter intensity calculation means which selects a predetermined pixel line out of a plurality of pixel lines crossing a block boundary as a typical pixel line for decoded image data of a moving image which are in units of blocks, and performs a filter intensity calculation to obtain a typical filter intensity based on pixel values included in said typical pixel line; and
typical filter means which provides smoothing for the pixel values included in said plurality of pixel lines based on said typical filter intensity.

2. The deblocking filtering processor according to claim 1, wherein said first deblocking filtering means selects a pixel line positioned in a middle portion of said block boundary as said typical pixel line.

3. The deblocking filtering processor according to claim 1, further comprising:
second blocking filtering means including: filter intensity calculation means calculating filter intensities for said plurality of pixel lines, respectively, based on pixel values included in said plurality of pixel lines, respectively, and filter means providing smoothing for the pixel values of said plurality of pixel lines based on said filter intensities; and
selection processing means selectively applying said first or second deblocking filtering means to said decoded image data based on inputted index data.

4. The deblocking filtering processor according to claim 3, wherein said first deblocking filtering means further includes typical block boundary selection means selecting a predetermined block boundary out of a plurality of block boundaries as a typical block boundary,
wherein said typical filter intensity calculation means calculates said typical filter intensity based on pixel values included in said typical pixel line on said typical block boundary, and
wherein said typical filter means provides smoothing for the pixel values included in the pixel lines belonging to said plurality of block boundaries.

5. The deblocking filter processor according to claim 3,
wherein said index data include at least one of a processing time of decoding processing of said decoded image data and a parameter necessary for deblocking filtering.

6. The deblocking filtering processor, according to claim 5, wherein said second deblocking filtering means performs a deblocking filtering defined in H.264/MPEG-4 AVC standard, and
wherein said parameters includes at least one of a bS (boundary strength) value, a QP (quantization parameter) value and a macro block type.

7. The deblocking filter processor according to claim 6, wherein said first deblocking filtering means includes at least one of:
first processing means calculating said typical filter intensity by using one of four pixel lines belonging to a 4×4 pixel block boundary and applying said typical filter intensity to smoothing processing of said four pixel lines to perform deblocking filtering;
second filtering means selecting as said typical pixel line a predetermined pixel line out of 16 pixel lines belonging to vertically or horizontally continuous 4×4 pixel block boundaries in a macro block in which 4×4 pixel blocks are arranged in a 4×4 matrix form, and applying said typical filter intensity to smoothing processing of said 16 pixel lines to perform deblocking filtering; and
third filtering means selecting as said typical pixel line a predetermined pixel line out of 64 pixel lines belonging to vertically and horizontally continuous 4×4 pixel block boundaries in said macro block, and applying said typical filter intensity to smoothing processing of said 64 pixel lines belonging to said vertically and horizontally continuous 4×4 pixel block boundaries to perform deblocking filtering, and
wherein said selection processing means switches between said first to third processing means and said second deblocking filter means, based on inputted index data in performing the deblocking filtering.

8. A deblocking filtering method, comprising:
performing first deblocking filtering processing which includes:
selecting a predetermined pixel line out of a plurality of pixel lines crossing a block boundary as a typical pixel line for decoded image data of a moving image that are coded in units of blocks;
calculating a typical filter intensity by performing a filter intensity calculation to obtain a typical filter intensity based on pixel values included in said typical pixel line; and
smoothing said pixel values included in said plurality of pixel lines based on said typical filter intensity.

9. The deblocking filtering method according to claim 8, wherein the selecting as said typical pixel line includes:
selecting a pixel line positioned in a middle portion of said block boundary as typical pixel line.

10. The deblocking filtering method according to claim 8, further comprising:
second blocking filtering processing including:
calculating filter intensities for said plurality of pixel lines, respectively, based on pixel values included in said plurality of pixel lines, respectively; and providing smoothing for said pixel values of said plurality of pixel lines based on said filter intensities; and
selectively applying said first or second deblocking filtering processing to said decoded image data based on inputted index data.

11. The deblocking filtering method according to claim 10, wherein the performing said first deblocking filtering processing further includes:
selecting a predetermined block boundary out of a plurality of block boundaries as a typical block boundary,
wherein the calculating said typical filter intensity includes calculating said typical filter intensity based on pixel values included in said typical pixel line on said typical block boundary, and
wherein the providing the smoothing based on said typical filter intensity includes providing the smoothing for the pixel values included in the pixel lines belonging to said plurality of block boundaries.

12. The deblocking filtering method according to claim 10,
wherein said index data include at least one of a processing time of decoding processing of said decoded image data and a parameter necessary for deblocking filtering.

13. The deblocking filtering method according to claim 12, wherein the performing said second deblocking filtering processing includes performing a deblocking filtering defined in H.264/MPEG-4 AVC standard, and
wherein said parameters includes at least one of a bS (boundary strength) value, a QP (quantization parameter) value and a macro block type.

14. The deblocking filtering method according to claim 13, wherein said first deblocking filtering processing includes at least one of:
selecting as said typical pixel line one of four pixel lines belonging to a 4×4 pixel block boundary to calculate said typical filter intensity by using, and applying said typical filter intensity to smoothing processing of said four pixel lines to perform deblocking filtering:
selecting as said typical pixel line a predetermined pixel line out of 16 pixel lines belonging to vertically or horizontally continuous 4×4 pixel block boundaries in a macro block in which 4×4 pixel blocks are arranged in a 4×4 matrix form to calculate said typical filter intensity, and applying said typical filter intensity to smoothing processing of said 16 pixel lines to perform deblocking filtering; and
selecting as said typical pixel line a predetermined pixel line out of 64 pixel lines belonging to vertically and horizontally continuous 4×4 pixel block boundaries in said macro block to calculate said typical filter intensity, and applying said typical filter intensity to smoothing processing of said 64 pixel lines belonging to vertically and horizontally continuous 4×4 pixel block boundaries to perform deblocking filtering, and
wherein said selectively applying includes a selecting, based on said index data, said applying said typical filter intensity to the smoothing processing of said four pixel lines to perform deblocking filtering, applying said typical filter intensity to smoothing processing of said 16 pixel lines to perform deblocking filtering to perform deblocking filtering and applying said typical filter intensity to smoothing processing of said 64 pixel lines to perform deblocking filtering, or performing said second deblocking filtering processing to perform deblocking processing.

15. A recording medium recording a deblocking filtering program which causes a computer to perform a first deblocking filtering processing including:
selecting a predetermined pixel line out of a plurality of pixel lines crossing a block boundary as a typical pixel line for decoded image data of a moving image that are coded in units of blocks;
calculating a typical filter intensity by performing a filter intensity calculation to obtain a typical filter intensity based on pixel values included in said typical pixel line; and
smoothing said pixel values included in said plurality of pixel lines based on said typical filter intensity.
